(19) United States
(12) Patent Application Publication
(10) Pub. No.: US 2014/0260534 A1
(43) Pub. Date: Sep. 18, 2014

(54) Biocompatible Filter

(71) Applicants: Mark Hahn, Oak Harbor, WA (US); Eric Beemer, Anacortes, WA (US)

(72) Inventors: Mark Hahn, Oak Harbor, WA (US); Eric Beemer, Anacortes, WA (US)

(73) Assignee: IDEX Health & Science LLC, Middleboro, MA (US)

(21) Appl. No.: 14/216,793

(22) Filed: Mar. 17, 2014

Related U.S. Application Data
(60) Provisional application No. 61/793,950, filed on Mar. 15, 2013.

(51) Int. Cl. B01D 15/08; H01J 49/02; G01N 30/02

(52) U.S. Cl. CPC B01D 15/08; G01N 30/02; H01J 49/02
USPC 73/23.35; 210/198.2; 264/628; 73/61.52; 250/281

(57) ABSTRACT

An improved biocompatible filter for use in liquid chromatography systems such as HPLC or UHPLC The present disclosure addresses the problem of particles bypassing a filter in a liquid chromatography application by design features in the interface between the frit filter and ring that form an improved seal between the ring and frit and prevent leakage around the filter in high measure chromatography. Design features also include frit filters with an internal particle size gradient for pre-column separation activity during filtration.

### BACKGROUND OF THE INVENTION

Liquid chromatography (LC), ion chromatography (IC), gas chromatography (GC), mass spectrometry (MS) and capillary electrophoresis are well-known techniques used in analytical systems for separating the constituent elements in a given sample. In a conventional LC system, a liquid solvent (referred to as the “mobile phase”) is introduced from a reservoir and is pumped through the LC system. The mobile phase exits the pump under pressure. The mobile phase then travels via tubing to a sample injection valve. As the name suggests, the sample injection valve allows an operator to inject a sample into the LC system, where the sample be carried along with the mobile phase. LC and related technologies, and associated tubing, ports, fittings, and other components are discussed in U.S. patent application Ser. Nos. 13/206,873 (published as US 2012/0024411), 13/292,667 (published as US 2012/0223520), and 13/686,260 (entitled “microfluidic interconnect”), each of which is incorporated herein by reference.

In a conventional LC system, the sample and mobile phase pass through one or more filters and often a guard column before coming to the column. A typical column usually consists of a piece of tubing which has been packed with a “packing” material. The “packing” consists of the particulate material “packed” inside the column. It usually consists of silica- or polymer-based particles, which are often chemically bonded with a chemical functionality. When the sample is carried through the column (along with the mobile phase), the various components in the sample migrate through the packing within the column at different rates (i.e., there is differential migration of the solutes). In other words, the various components in a sample will move through the column at different rates. Because of the different rates of movement, the components gradually separate as they move through the column. Differential migration is affected by factors such as the composition of the mobile phase, the composition of the stationary phase (i.e., the material with which the column is “packet”), and the temperature at which the separation takes place. Thus, such factors will influence the separation of the sample's various components.

Once the sample (with its components now separated) leaves the column, it flows with the mobile phase past a detector, which can be built using MEMS technology. The detector detects the presence of specific molecules or compounds. Two general types of detectors are typically used in LC applications. One type measures a change in some overall physical property of the mobile phase and the sample (such as their refractive index). The other type measures some properties of only the sample (such as the absorption of ultraviolet radiation). In essence, a typical detector in a LC system can measure and provide an output in terms of mass per unit of volume (such as grams per milliliter) or mass per unit of time (such as grams per second) of the sample's components. From such an output signal, a “chromatogram” can be provided; the chromatogram can then be used by an operator to determine the chemical components present in the sample. Additionally, LC systems may utilize mass spectrometric detection for identification and quantification of the sample, either in addition to, or as an alternative to, the conventional detectors described previously. Ion chromatography relies on the detection of ions in solution, so most metallic materials in the flow path can create interference in the detection scheme, as they create background ions.

In addition to the above components, an LC system will often include filters, check valves, a guard column, or the like in order to prevent contamination of the sample or damage to the LC system. For example, an inlet solvent filter may be used to filter out particles from the solvent (or mobile phase) before it reaches the pump. A guard column is often placed before the analytical or preparative column; i.e., the primary column. The purpose of such a guard column is to “guard” the primary column by absorbing unwanted sample components that might otherwise bind irreversibly to the analytical or preparative column.

In practice, various components in an LC system may be connected by an operator to perform a given task. For example, an operator will select an appropriate mobile phase and column, and then connect a supply of the selected mobile phase and a selected column to the LC system before operation. In order to be suitable for high performance liquid chromatography (HPLC) applications, each connection must be able to withstand the typical operating pressures of the LC system. If the connection is too weak, it may leak. Because the types of solvents that are sometimes used as the mobile phase are often toxic and because it is often expensive to obtain and/or prepare many samples for use, any such connection failure is a serious concern. A high pressure fitting is further discussed in U.S. patent application Ser. No. 13/038,110 (published as U.S. Patent Publication No. US 2012/0223522 A1), the contents of which are incorporated herein by reference.

Most conventional HPLC systems include pumps which can generate relatively high pressures of up to around 5,000 psi to 6,000 psi or so. In many situations, an operator can obtain successful results by operating an LC system at “low” pressures of anywhere from just a few psi or so up to 1,000 psi or so. More often than not, however, an operator will find it desirable to operate a LC system at relatively “higher” pressures of over 1,000 psi. If a connection does not have sufficient structural strength, it could leak at higher pressures.

Another, relatively newer liquid chromatography form is Ultra High Performance Liquid Chromatography (UHPLC) in which system pressure extends upward to 1400 bar or 20,000 psi. Both HPLC and UHPLC are examples of analytical instrumentation that utilize fluid transfer at elevated pressures. For example, in U.S. Pat. No. 8,173,078 (entitled “Sample Injector System for Liquid Chromatography”), an injection system is described for use with UHPLC applications, which are said to involve pressures in the range from 20,000 psi to 120,000 psi. In U.S. Pat. No. 7,311,502 (entitled “Method for Using a Hydraulic Amplifier Pump in Ultrahigh Pressure Liquid Chromatography”), the use of a hydraulic amplifier is described for use in UHPLC systems involving pressures in excess of 25,000 psi. In U.S. Pat. No. 7,144,502 (entitled “Chromatography System with Gradient Storage and Method for Operating the Same”), a system for performing UHPLC is disclosed, with UHPLC described as involving pressures above 5,000 psi (and up to 60,000 psi). Applicants hereby incorporate by reference as if fully set forth herein U.S. Pat. Nos. 7,311,502; 7,14,502; and 8,173,078.

Given the desirability of need for leak-free connections, conventional connections have been made with stainless steel tubing and stainless steel end fittings. More recently, however, it has been realized that the use of stainless steel components in a LC system can have potential drawbacks in situations involving biological samples, and cannot be routinely used for ion chromatography. For example, the components in a sample may attach themselves to the wall of stainless steel tubing. This can present problems because the detector's measurements (and thus the chromatogram) of a given sample may not accurately reflect the sample if some of the sample's components or ions remain the tubing and do not pass the detector. Perhaps of even greater concern, however, is the fact that ions from the stainless steel tubing may detach from the tubing and flow past the detector, thus leading to potentially erroneous results. Hence, there is a need for biocompatible connections though the use of a material that is chemically inert with respect to such biological samples and the mobile phase used with such samples, so that ions will not be released by the tubing and thus contaminate the sample. Such connections and tubing are further described in U.S. patent application Ser. No. 13/206,873 (published as US 2012/0024411), the contents of which are incorporated herein by reference.

In the past, many filters for high pressure LC applications were made of metal or otherwise had metallic parts which contacted the mobile phase. For example, stainless steel and titanium filters have been used. Conventional metallic filters have been made via sintering, such as is described in U.S. Pat. No. 4,966,696, which is hereby incorporated by reference. However, such metallic filters are not biocompatible.

On the other hand, those few filters which were made of biocompatible materials (such as ultra-high molecular weight polyethylene) were made of plastic materials that could only be used with a limited number of the solvents often used as the mobile phase in many HPLC applications. For example, a “biocompatible” filter made of polyetheretherketone (PEEK) and polytetrafluoroethylene (PTFE) is commercially available from Alltech Associates, Inc. The polytetrafluoroethylene is not very strong, however, and wears quickly. When such a filter wears down, pieces of the filter break off, thereby leading to the risk of damage of other components of the LC system and contamination of the sample to be studied. Hence, such conventional filters cannot be used in many HPLC applications. As a result, there is a need for a filter which is biocompatible and which can be used in relatively high pressure applications with a variety of mobile phases without leasing or otherwise falling.

An improved biocompatible filter made of a sintered biocompatible powder is described in U.S. Pat. No. 5,651,931 (incorporated herein in its entirety by reference fir all purposes). In the described methods of producing the filters, a biocompatible powder with a desired average particle size is placed in a die and press apparatus and is then pressed to form a “cake” of the biocompatible powder. The cake is then heated to a preselected temperature, which is maintained for a predetermined amount of time. By heating the biocompatible powder cake for the appropriate amount of time at the appropriate temperature, the biocompatible powder is sintered so that the particles of the powder bond together to form a biocompatible filter. The resulting biocompatible filter is removed from the heating apparatus after the preselected time period has elapsed and is then allowed to cool. A preferred biocompatible material is polyether ether ketone (PEEK).

More recent trends in ultra high pressure liquid chromatography (UHPLC) have driven column packing particle sizes smaller, which in turn have driven up system pressures. This poses new challenges for UHPLC particle filtration. Current designs of PEEK filters rely on press-fit between the filtration element and the holding ring. Under higher pressure, there is a possibility that small particulates can bypass the filter element and squeeze between the frit disc and frit ring. There is a need, therefore, for a new design that more securely eliminates this path of particle “blow-by”.

### SUMMARY

The present disclosure addresses the problem of particles bypassing a filter in a liquid chromatography application by design features in the interface between the frit filter and ring that form an improved seal between the ring and frit. In certain preferred embodiment, the frit filter is provided with an undercut as shown herein. The design provides a number of advantages including improved mechanical retention of the frit (from being pushed out) and subsequent reduction of blow by of particulate material such as column packing beads pump and valve wear debris, or unfiltered sample particulates.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is a block diagram of a typical LC system.

FIG. 2 is a prior art ringed frit.

FIG. 3 is a cross-sectional view of an embodiment of the disclosure.

FIG. 4 is a cross-sectional view of an embodiment of the disclosure.

FIG. 5A is a prior art filter housing.

FIG. 5B is an embodiment of the disclosure disposed in a filter housing.

FIG. 6 is an example of an embodiment of the disclosure in a union connector.

FIG. 7 is cross-sectional view of an embodiment of the disclosure.

FIG. 8A-E are cross-sectional views of embodiments of the disclosure.

### DETAILED DESCRIPTION

In FIG. 1, a block diagram illustrating an example of an environment in which a filter as discussed herein may be utilized is provided, with the basic and essential elements of an LC system shown. A reservoir 1 contains a solvent or mobile phase 2. Tubing 3 connects the mobile phase 2 in the reservoir 1 to a pump 4. The pump 4 is connected via tubing to a sample injection valve 5 which, in turn, is connected via tubing to a first end of a column 6. The second end of the column 6 is then connected via tubing to a detector 7. After passing through the detector 7, the mobile phase 2 and the sample injected via injection valve 5 are transported via tubing into a second reservoir 8, which contains the chemical waste 9. Data from the detector 7 can be relayed to a recording device 10 which can generate a paper printout of the information obtained by the detector 7. As noted above, the sample injection valve 5 is used to inject as sample of a material to be studied into the LC system. In operation, the mobile phase 2 flows though the tubing 3, which is used to connect the various elements of the LC system together. Although described herein principally with respect to a liquid chromatography system, the disclosed filters are also applicable to other analytical instrumentation systems such as ion chromatography (IC), gas chromatography (GC), mass spectrometry (MS), capillary electrophoresis, and other applications known to those of skill in the art.

When the sample is injected via sample injection valve 5 in the LC system, the sample is carried by the mobile phase through the tubing into the column 6. As is well known in the art, the column 6 contains a packing material which acts to separate the constituent elements of the sample. After exiting the column 6, the sample (as separated via the column 6) then is carried to and enters a detector 7, which detects the presence or absence of various ions. The information obtained by the detector 7 can then be stored by well-known means (such as a personal computer programmed to do so) and used by an operator of the LC system to determine the constituent elements of the sample injected into the LC system.

The present disclosure provides improvements to liquid chromatography filters, and in certain embodiments to biocompatible PEEK frit filters. Conventional frit filters (or “frits”) as shown in FIG. 2 often include as ring structure 11 that provides a central aperture for holding a frit filter 12, that fits within the ring with a press fit. Although not completely visible in the drawing, the prior art frit is a basic cylinder shape for a close fit with the cylindrical aperture. As stated above, this type of press fit has the potential for leakage between the frit and ring, particularly in ultra high pressure applications.

An embodiment of the present disclosure is shown in FIG. 3 in cross-section. In this embodiment, the ring 15 has been altered to accommodate the improved frit 16, which has been modified with an undercut 17 from both its top and bottom surfaces, creating a radial projection from the midpoint of the frit. The undercuts can be molded into the frit as it is formed by adding the features to the press tooling or by secondary operations such as machining or grinding.

As stated above, the frits can be produced by methods described in U.S. Pat. No. 5,651,931 (incorporated herein in its entirety). A preferred biocompatible material for the frit is polyether ether ketone (PEEK). PEEK of various grades is commercially available from Aetna Plastics Corp. of Cleveland, Ohio or Victrex USA, Inc. of West Conshohocken, Pa. Although PEEK can be difficult to use from a manufacturing standpoint, it has the advantage of strength and is chemically inert to most solvents used as the mobile phase in LC applications. PEEK is commercially available in pellet and powder form. To be useful in accordance with the present invention, a powder is needed. The particular size of the powder is important in obtaining and controlling the desired filtering characteristics of the filter to be made for LC filters.

The following is a description of an example of a method of producing frits, but as is well known in the art, various changes can be made to certain parameters of this method such as temperature, pressure and incubation times, for example to achieve a satisfactory result. For example, this method may be directed to a frit of a certain size or density and would need to be amended to accommodate the selected frits. All such changes that would be within the knowledge of the person of skill in this art are contemplated by this disclosure.

Once purchased, PEEK pellets can be ground by conventional techniques to form a fine powder. The powder can be screened by a conventional mesh screen or can be sized by a conventional air classifier to provide a powder with particles of a desired size in order to obtain a filter with the desired filtering characteristics. For a 2 μm filter, for example, an average particle size of 90 μm is preferred. A mesh screen (of size 60) can be use to obtain a PEEK powder with a maximum particle site of less than 45 μm. The PEEK powder can be sifted by conventional means. For example, to Ro-Tap® and screens with as numbers 60 and 170 can be used for sifting the PEEK powder in connection with making a 2 μm frit. Typically, the PEEK powder is sifted through all of the screens (depending upon the size of the desired frit) for approximately twenty to thirty minutes or so, or until all of the PEEK powder has passed through all of the relevant screens. The Ro-Tape® and mesh screens are commercially available from W.S. Tyler® Industrial Group of Mentor, Ohio.

Once the PEEK powder has been sized (such as by screening or air classifying), the powder needs to be pressed. An appropriate amount of the powder is introduced into a die with a central bore. When the die is in a loading position a facing section extends into the bottom portion of the bore. A power press is partially inserted into the bore. The lower press is positioned so that the distance between the top of the facing section and the top of the die is equal to the “fill height.”

In order to obtain a filter of the desired shape and size, an appropriate amount of the PEEK powder needs to be placed into the bore. The proper amount of PEEK powder can be determined by calculating the appropriate fill height (h_{f}) in accordance with the following formula:

h_{f}=[(thick_{f}/(1+% Δ from sintering))×(Δp/Fₚ)] where thick_{f}=desired final thickness of Frit.

Δp=pressed theoretical density %, and

Fₚ=picking fraction.

An alternative method for obtaining the approximate amount of the PEEK powder is to weigh the PEEK powder that goes into the bore. Empirically, the pressed theoretical density % (Δp) of PEEK is 0.85. In addition, the packing fraction (Fₚ) represents the ratio of the apparent density to the theoretical density of the material (i.e., Fₚ=Δₐ/Δₜₕ). The apparent density (Δₐ) of the PEEK varies and should be determined after the powder is sifted.

Once the desired fill height (h_{f}) has been determined in accordance with the above procedure, an operator can position the lower press so that the distance from the facing section to the top of the die equals the predetermined height. Alternatively, the die can be machined to accommodate the fill height. Once the lower press has been positioned to provide the desired fill height, an operator can simply pour enough PEEK powder into the bore to fill the bore to the desired fill height (h_{f}). If needed, the operator can remove any excess PEEK powder from the die by scraping it away or can add additional PEEK powder and cheek again until the desired fill height (h_{f}) is achieved.

Once the correct, predetermined amount of PEEK powder has been placed in the bore, an upper press is lowered. The facing section of the upper press extends into the bore. When closed, the upper facing section is pressed downwards by a conventional press apparatus. This exerts compaction force on the PEEK powder. A preferred compaction force is approximately 200 MPa for each frit for some frits but can vary depending on the desired product. This force should be uniform over the surface area of each frit. This pressing operation can last anywhere from a few milliseconds to several minutes.

After the PEEK powder has been pressed, the upper press is first raised. The lower press is then pushed further into and through the bore. Thus, the lower press pushes the pressed PEEK powder out of the die. The pressing operation essentially forms “cakes” of the now-compressed PEEK powder.

Once the lower press has ejected the “cakes,” they can be plated onto a clean tray. The PEEK powder “cakes” are then placed into a heating device, such as an oven. The oven can be a conventional batch oven, such as are commercially available from Blue M or Griese. An operator then adjusts the oven to heat the PEEK powder. Preferred heating parameters for the PEEK powder include a rate of approximately 75° C. per minute, ±0.5° C. per minute. The PEEK powder should be heated to approximately 340° C., ±0.2° C. (e.g., “substantially 340° C.”), or to the softening temperature of the particular grade of PEEK being used and held at that temperature for about twenty to thirty minutes or more. Maintaining the PEEK powder at this temperature sinters the PEEK powder to form filters of the desired shape and filtering characteristics. After the PEEK powder has been sintered it is removed from the oven and allowed to cool at room temperature.

The ring can be formed by a variety of methods, such as injection insert molding, machining, compression molding, solution casting, powder sintering, etc. When the same (PEEK) or miscible polymer is molded by a melt-processing method onto a PEEK frit, a molecular bond can be formed if the proper process conditions are employed. The ring can be mounted around the frit in a number of ways including, but not limited to molding, hot or cold pressing, mechanical assembly, reflow molding, or with adhesives. A preferred method is insert injection molding of a PEEK ring directly onto a PEEK frit. Insert molding is a method of infection molding in which the frit is installed inside the cavity while the mold is open, the mold is then closed and the injection molding is carried out.

The undercut design shown in FIG. 3 also enables to secondary mechanical sealing mechanism. When the frit is installed into a column or filter housing, force can be applied to the face of the ring so that the ring is squeezed against the frit, providing a seal. This mechanism can be enhanced by added features to the ring, such as taper, draft, ridges, lips, or any related design feature that reduces cross-sectional area of the sealing surface and focuses sealing forces towards the inner diameter of the ring. A ring with a taper design is shown in FIG. 4 This mechanical force can be used to further strengthen the molecular bond formed during insert molding of miscible polymers but can also be used with dissimilar materials. For example, a softer material, such as a fluoropolymer, can be molded around the frit. There would be no molecular bond between fluoropolymer, but the prevention of blow-by can be accomplished by mechanical force on the ring or by the tortuous path created by the undercut feature. The softer fluoropolymer ring would create a fluidic seal at lower tightening torque versus PEEK.

An example of a commercially available housing that delivers compression to the frit ring is shown in FIG. 5A. In this design, a first component of the housing provides a seat for a frit ring 22 and internal threads. The second component 23 provides external threads that mate with the first component. As the components are screwed together, the frit is pressed against the seat. The components also include connection ports 24 for the tubing. In FIG. 5A, as conventional frit is shown. As shown in FIG. 5B, however, a frit containing an undercut as described herein is compatible with that standard housing components. An inventive frit ring 30 as disclosed herein is shown in FIG. 5B in a conventional housing as shown in FIG. 5A.

It is a further aspect of the disclosure that the molded ring can be enhanced with as functional housing, such as a filter housing, column end fitting, or other fluidic conduit. For example, a metal threaded housing 35 is machined, a frit 36 with undercuts positioned in the center of the cavity 37, and PEEK material is injection molded into the steel housing, encapsulating and holding the PEEK frit within the metal filter housing as shown in FIG. 6. Although the example in FIG. 6 is a preferred embodiment, the invention is not limited to such a filter housing, but any number of configurations can be made with this method of molding material around a PEEK frit (with or without undercuts) to secure it in place. Some common HPLC applications include chromatography column and column packing hardware, end fittings, inline filters, pro-column filters, bottom of bottle filters, sparging hardware, static mixers, syringe filters and other uses known to those of skill in the art.

In yet another aspect of the disclosure, any of the embodiments described herein can be made with a PEEK frit with a density gradient as shown in FIG. 7. The example shown includes a ring 40 holding an undercut frit 41 with a density gradient. Particles 42 of differing sizes are layered and then molded, yielding a frit having integrated pre-filter functionality, effectively increasing the particle holding capacity of the frit disc. This technology can be used in any of the frit discs described herein or known in the art, including those with or without undercuts, as shown in FIG. 3, or with or without rings, or housings.

A variety of other geometries of filters can also be utilized, some of which are shown in FIGS. 8A-E. For example, FIGS. 8A-8D are examples of different channels in the sides of the discs. FIG. 8E is an example of an arced projection from the disc. Although described as projections or even as indentions into the disc, it is understood that the described filters can be molded in that shape or shaped after molding. In certain embodiments two filters can be pressed or molded into a single ring to achieve the effective shape. FIGS. 8C and 8D illustrate how two filters can be used to achieve a particular shaped filter. This technique can be particularly advantageous when producing a density gradient filter or when pressing an undercut filter as in FIG. 3 into a ring.

All of the devices and methods disclosed and claimed herein can be made and executed without undue experimentation in light of the present disclosure. While the devices and methods of this invention have been described in terms of preferred embodiments, it will be apparent to those of skill in the art that variations may be applied to the devices an for methods and in the steps or in the sequence of steps of the methods described herein without departing from the concept, spirit and scope of the invention. All such similar substitutes and modifications apparent to those skilled in the art are deemed to be within the spirit, scope and concept of the invention as defined by the appended claims.

1. A filter assembly suitable for high pressure liquid chromatography comprising a ring structure comprising first and second planar surfaces and a central channel, and a filter disposed in the central cannel of the ring structure and sized to fit in the channel with a press fit seal, wherein the filter further comprises one or more geometrical features at the interface of the filter and ring effective to mechanically retain and seal the filter inside the ring.

2. The filter assembly of claim 1, wherein two filters of different geometry are disposed in the central channel.

3. The filter assembly of claim 1 wherein the filter is made from a disc structure with undercuts around the edges of the planar end surfaces of the disc.

4. The filter assembly of claim 3, wherein the filter is made from a disc structure and the undercuts are made by machining or grinding the disc.

5. The filter assembly of claim 3, wherein the undercuts are molded into the filter as it is formed by adding the features to a press tooling.

6. The filter assembly of claim 1, wherein the filter comprises sintered PEEK.

7. The filter assembly of claim 1, wherein the ring structure comprises PEEK.

8. The filter assembly of claim 1, wherein the ring structure comprises a fluoropolymer.

9. The filter assembly of claim 1, wherein the filter is comprised of a particle size gradient in the direction of liquid flow through the filter.

10. The filter assembly of claim 1, wherein the filter comprises PEEK and the ring structure comprises a miscible polymer molded onto the PEEK filter by a melt-processing method.

11. The filter assembly of claim 1, wherein the filter comprises PEEK and the ring is bonded to the filter by a molecular bond, a melt bond, a hot or cold press bond, a reflow molded bond or an adhesive bond.

12. The filter assembly of claim 1, wherein the ring comprises a taper, a draft, a ridge, or lips, effective to reduce cross-sectional area of the sealing surface and focus sealing forces toward the inner diameter of the ring.

13. A housing suitable for a filtration application in to liquid chromatography system comprising the filter assembly of claim 1.

14. The housing of claim 13, wherein the housing is a filter housing a column end fitting, a chromatography column, a column packing device, an end fitting, an inline filter, a pre-column filter, a bottom of bottle filter, a sparging device, a static mixer, or a syringe filter.

15. The housing of claim 13 produced by a process including providing a metal housing suitable for a filtration application in a liquid chromatography system and comprising a cavity for holding a frit filter in the fluid flow channel of the chromatography system, placing a PEEK disc in the cavity in the fluid flow channel and injection molding a PEEK material into the cavity to form a ring structure around the PEEK disc.

16. A frit filter suitable for high pressure liquid chromatography filtration wherein the frit filter comprises a disc comprised of sintered PEEK particles, wherein the PEEK particles are layered in a size gradient in the direction of liquid flow through the filter.

17. A method of manufacturing a filter comprising:
grinding particles of a biocompatible polymer into a powder;
screening the powder to obtain powder of a selected particle size;
pressing a measured amount of powder of a selected particle size in a press mold of the desired shape to obtain a cake of pressed powder of the desired shape; and
heating the cake of pressed powder to the softening temperature of the material and holding at that temperature to sinter the polymeric powder;
wherein the filter comprises one or more geometrical features at the interface of the filter and ring during use effective to mechanically retain and seal the filter inside the ring.

18. The method of claim 17 wherein particles of different sizes are added to the press mold in layers in order to achieve a particle size gradient in the filter.

19. The method of claim 17, wherein the desired shape is a disc with lateral projections from the side of the disc shape.

20. The method of claim 17, wherein the desired shape is designed to be combined with another filter in a single ring to obtain the desired geometry.

21. The method of claim 17, further comprising providing a ring that fits the filter with a press seal fit and sealing the filter in the ring.

22. The method of claim 21, wherein the ring is molded on the filter.

23. The method of claim 17, wherein the biocompatible polymer is PEEK.

24. The method of claim 21, wherein the ring comprises PEEK or a fluoropolymer.

25. A filter made by the process of claim 17.

26. An analytical instrument comprising a filter of claim 1.

27. The analytical instrument of claim 26, wherein the instrument is a liquid chromatography (LC), ion chromatography (IC), gas chromatography (GC), mass spectrometry (MS) or capillary electrophoresis analytical instrument.
